(19) United States
(12) Patent Application Publication
(10) Pub. No.: US 2004/0107087 A1
(43) Pub. Date: Jun. 3, 2004

(54) Circuit operation simulating apparatus

(75) Inventors: Masahiro Fukui, Osaka (JP); Yusuke Tokunaga, Osaka (JP)

Correspondence Address: Jack Q. Lever, Jr., McDERMOTT, WILL & EMERY, 600 Thirteenth Street, N.W., Washington, DC, 20005-3096, US

(73) Assignee: MATSUSHITA ELECTRIC INDUSTRIAL CO., LTD.

(21) Appl. No.: 10/715,486

(22) Filed: Nov. 19, 2003

(30) Foreign Application Priority Data
Nov. 21, 2002 (JP) 2002-337898

(51) Int. Cl. G06F 9/455

(52) U.S. Cl. 703/26

(57) ABSTRACT

Circuit information supplied in an encrypted state (supplied circuit information) is decrypted by a supplied circuit information decrypting section and then encrypted by a stored circuit information encrypting section, to be stored in a storage section as stored circuit information. The stored circuit information is decrypted by a stored circuit information/intermediate data decrypting section and is input to a simulator engine, thereby performing a simulation. Intermediate data generated during the simulation is encrypted by an intermediate data encrypting section, stored in the storage section, decrypted also by the stored circuit information/intermediate data decrypting section, and then input to the simulator engine. In this manner, the simulation is easily performed, while enhancing the confidentiality of the circuit information.

### BACKGROUND OF THE INVENTION

The present invention relates to a technology relating to circuit operation simulating apparatus for simulating operation of electronic circuits and, in particular, electronic circuits using semiconductor integrated circuits.

Conventionally, circuit operation simulating apparatus has been used to verify design and operation of electronic circuits, for example. Specifically, circuit operation is simulated by obtaining signal levels of respective sections in an electronic circuit to be simulated, based on circuit information on the electronic circuit and simulation input data indicating, for example, an input signal to the circuit, stored in a storage section as, for example, a circuit library (e.g., Japanese Laid-Open Publication No. 8-180088). In a case where a semiconductor integrated circuit delivered from another manufacturer is included in the electronic circuit to be simulated, circuit operation of the whole electronic circuit is simulated by storing the circuit information on the semiconductor integrated circuit received from the manufacturer, in the storage section together with information on other circuits (e.g., a peripheral circuit). In this manner, the entire operation of the electronic circuit including operation of the semiconductor integrated circuit and the entire function thereof (e.g., a relationship between input or output signals or an internal state) can be verified and the peripheral circuit can be optimized, for example.

The circuit information for use in the simulation of the circuit operation includes information indicating characteristics of elements constituting the circuit and information indicating a connection relationship between the elements. As a format of expression of the circuit information, a format such as a text data format according to a form normally used in the art is used. Specifically, a source list format for a simulator, notably an apparatus called a SPICE, a hardware description language format, notably a Verilog-HDL, and a layout data format are used, for example. That is to say, circuit information described in accordance with certain rules open to the public is used, so that many kinds of circuit operation simulating apparatuses can perform simulations based on circuit information supplied from manufacturers of semiconductor integrated circuits.

The known circuit operation simulating apparatus is configured to perform a simulation based on circuit information in a format normally used as described above, thereby allowing a simulation of operation of electronic circuits using semiconductor integrated circuits provided from various manufacturers. However, circuit information in such a format is described in accordance with certain rules open to the public. Therefore, if a user provided with a semiconductor integrated circuit, for example, analyzes the circuit information, the user can easily grasp types of elements used in the semiconductor integrated circuit and a connection relationship between the elements, i.e., design information such as know-how in circuit design and trends in development. In view of this, when circuit information on a semiconductor integrated circuit is provided, a contract for holding confidentiality called a Non-Disclosure Agreement (NDA) is generally concluded, for example. However, such a type of contract needs much effort in legal formalities, and therefore becomes a cause of increased fabrication costs for semiconductor integrated circuits and products using these circuits. In addition, users provided with semiconductor integrated circuits have an inconvenience of being prohibited from developing a technique relating to the presented circuit information by themselves. Hence, in fact, simulations of circuits including the semiconductor integrated circuits cannot be easily performed unless there is high probability of application of the semiconductor integrated circuits.

In addition, a technique with which a design processor performs processing upon design information from an encrypted design file is disclosed in U.S. Pat. No. 5,978,476. The design information from the encrypted design file is stored in a random access memory (RAM), for example. The design information stored in, for example, the RAM is not readily accessible as compared to data held as files on, for example, a hard disk, but it is not so difficult to access the design information if a technique such as a general memory dump is used. Accordingly, it is difficult to obtain high confidentiality. In addition, if temporary data generated through a simulation process is read out on purpose or not, the confidentiality is not ensured either. Moreover, since storage capacity of a RAM or the like is much smaller than that of a hard disk, it is difficult to perform a simulation of a large-scale circuit.

### SUMMARY OF THE INVENTION

It is therefore an object of the present invention to allow a circuit operation simulation apparatus to perform a simulation easily, while ensuring confidentiality of circuit information.

In order to achieve this object, a first circuit operation simulation apparatus of the invention is characterized by including: simulation means for simulating operation of a circuit based on circuit information on a configuration and characteristics of the circuit; storage means for storing encrypted circuit information; stored circuit information decrypting means for reading out the encrypted circuit information from the storage means, decrypting the circuit information, and providing the decrypted circuit information to the simulation means; intermediate data encrypting means for encrypting intermediate data generated during a simulation by the simulation means and storing the encrypted intermediate data in the storage means; and intermediate data decrypting means for reading out the encrypted intermediate data from the storage means, decrypting the intermediate data, and providing the decrypted intermediate data to the simulation means.

With this configuration, circuit information for a simulation of circuit operation can be supplied in an encrypted state, thus ensuring confidentiality. Accordingly, the circuit information can be supplied in a flexible manner such as using the Internet or via a middleperson. In addition, even if a user accidentally sees the content stored in the storage means, the user cannot know any of the circuit information and intermediate data so that confidentiality is ensured. Thus, it is unnecessary to conclude a contract such as a NDA and thus, a simulation can be easily performed. In particular, since the intermediate data is also encrypted, the confidentiality of the circuit information can be ensured even in a case where the simulation is aborted abnormally by an error and the intermediate data remains in the storage means.

A second circuit operation simulating apparatus of the invention is the first circuit operation simulating apparatus and is characterized in that the stored circuit information decrypting means and the intermediate data decrypting means are combined together.

In this way, the configuration of the apparatus can be simplified.

A third circuit operation simulating apparatus of the invention is the first circuit operation simulating apparatus and is characterized by further including intermediate data deleting means for deleting the intermediate data stored in the storage means, after the simulation has been terminated.

With this configuration, it is possible to prevent the revelation of the circuit information when the user of the circuit operation simulating apparatus accidentally sees the content stored in the storage means, after the termination of the simulation.

A fourth circuit operation simulating apparatus of the invention is characterized by including: simulation means for simulating operation of a circuit based on circuit information on a configuration and characteristics of the circuit; supplied circuit information decrypting means for decrypting supplied circuit information encrypted by a first encryption technique; stored circuit information encrypting means for encrypting, by a second encryption technique, the circuit information decrypted by the supplied circuit information decrypting means; storage means for storing the circuit information encrypted by the second encryption technique; and stored circuit information decrypting means for reading out the circuit information encrypted by the second encryption technique from the storage means, decrypting the circuit information, and providing the decrypted circuit information to the simulation means.

A fifth circuit operation simulating apparatus of the invention is the fourth circuit operation simulating apparatus and is characterized in that the encryption by the first encryption technique has an encryption strength higher than that by the second encryption technique.

A sixth circuit operation simulating apparatus of the invention is the fourth circuit operation simulating apparatus and is characterized in that the encryption by the second encryption technique requires shorter time for encryption and decryption than that by the first encryption technique.

A seventh circuit operation simulating apparatus of the invention is the fourth circuit operation simulating apparatus and is characterized in that the circuit information decrypted by the supplied circuit information decrypting means is not stored in the storage means but encrypted by the stored circuit information encrypting means.

With this configuration, the confidentiality at the stage of distribution via, for example, the Internet is enhanced, while increasing the speed of decryption for a simulation, by having two types of encryption techniques: an encryption technique in supplying circuit information; and an encryption technique in storing the circuit information in the storage means.

An eighth circuit operation simulating apparatus of the invention is the fourth circuit operation simulating apparatus and is characterized by further including: intermediate data encrypting means for encrypting intermediate data generated during a simulation by the simulation means and for storing the encrypted intermediate data in the storage means; and intermediate data decrypting means for reading out the encrypted intermediate data from the storage means, decrypting the intermediate data, and providing the decrypted intermediate data to the simulation means, wherein the stored circuit information encrypting means and the intermediate data encrypting means are combined together.

With this configuration, the confidentiality of the circuit information at the stage of distribution is ensured and the speed of a simulation is increased, as described above. In addition, the configuration of the apparatus is simplified, while preventing the revelation of the circuit information caused by an exposure of the intermediate data.

A ninth circuit operation simulating apparatus of the invention is characterized by including: simulation means for simulating operation of a circuit based on circuit information on a configuration and characteristics of the circuit; and storage means for storing encrypted circuit information, wherein the circuit operation simulating apparatus is configured to be able to incorporate: stored circuit information decrypting means for decrypting the encrypted circuit information read out from the storage means and for providing the circuit information to the simulation means; intermediate data encrypting means for encrypting intermediate data generated during a simulation by the simulation means and for storing the encrypted intermediate data in the storage means; and intermediate data decrypting means for decrypting the encrypted intermediate data read out from the storage means and for providing the decrypted intermediate data to the simulation means.

A tenth circuit operation simulating apparatus of the invention is characterized by including: simulation means for simulating operation of a circuit based on circuit information on a configuration and characteristics of the circuit; and storage means for storing encrypted circuit information, wherein the circuit operation simulating apparatus is configured to be able to incorporate: supplied circuit information decrypting means for decrypting supplied circuit information encrypted by a first encryption technique; stored circuit information encrypting means for encrypting, by a second encryption technique, the circuit information decrypted by the supplied circuit information decrypting means, and for storing the encrypted circuit information in the storage means; and stored circuit information decrypting means for decrypting the circuit information read out from the storage means and encrypted by the second encryption technique, and for providing the decrypted circuit information to the simulation means.

In this manner, a circuit operation simulating apparatus capable of enhancing the confidentiality of circuit information by encryption as described above is configured easily. In addition, an encryption algorithm is updated easily.

A first circuit operation simulating method of the invention is characterized by including: a simulation step of simulating operation of a circuit based on circuit information on a configuration and characteristics of the circuit; a stored circuit information decrypting step of reading out encrypted circuit information from storage means and decrypting the circuit information for use in the simulation step; an intermediate data encrypting step of encrypting intermediate data generated during a simulation in the simulation step and of storing the encrypted intermediate data in the storage means; and an intermediate data decrypting step of reading out the encrypted intermediate data from the storage means and decrypting the intermediate data for use in the simulation step.

A second circuit operation simulating method of the invention is characterized by including: a simulation step of simulating operation of a circuit based on circuit information on a configuration and characteristics of the circuit; a supplied circuit information decrypting step of decrypting supplied circuit information encrypted by a first encryption technique; a stored circuit information encrypting step of encrypting, by a second encryption technique, the circuit information decrypted in the supplied circuit information decrypting step and of storing the encrypted circuit information in storage means; and a stored circuit information decrypting step of reading out the circuit information encrypted by the second encryption technique from the storage means and of decrypting the circuit information for use in the simulation step.

A first circuit operation simulating program of the invention is characterized by making a computer execute: a simulation step of simulating operation of a circuit based on circuit information on a configuration and characteristics of the circuit; a stored circuit information decrypting step of reading out encrypted circuit information from storage means and decrypting the circuit information for use in the simulation step; an intermediate data encrypting step of encrypting intermediate data generated during a simulation in the simulation step and of storing the encrypted intermediate data in the storage means; and an intermediate data decrypting step of reading out the encrypted intermediate data from the storage means and decrypting the intermediate data for use in the simulation step.

A second circuit operation simulating program is characterized by making a computer execute: a simulation step of simulating operation of a circuit based on circuit information on a configuration and characteristics of the circuit; and a supplied circuit information decrypting step of decrypting supplied circuit information encrypted by a first encryption technique, a stored circuit information encrypting step of encrypting, by a second encryption technique, the circuit information decrypted in the supplied circuit information decrypting step and of storing the encrypted circuit information in storage means, and a stored circuit information decrypting step of reading out the circuit information encrypted by the second encryption technique from the storage means and of decrypting the circuit information for use in the simulation step.

With these circuit operation simulating methods or circuit operation simulating programs, circuit information for a simulation of circuit operation can also be supplied in an encrypted state so that confidentiality is ensured. Accordingly, the circuit information can be supplied in a flexible manner such as using the Internet or via a middleperson. In addition, even if a user accidentally sees the content stored in the storage means, the user cannot know the circuit information so that confidentiality is ensured. Thus, it is unnecessary to conclude a contract such as a NDA and thus, a simulation can be easily performed.

Further, since no substantial revelation of the circuit information to the user based on intermediate data occurs, the confidentiality of the circuit information is also ensured. In particular, even in a case where a simulation is aborted abnormally by an error and the intermediate data remains in the storage means, for example, the confidentiality of the circuit information can be ensured.

Moreover, the confidentiality at the stage of distribution via, for example, the Internet is enhanced, while increasing the speed of decryption for a simulation, by having two types of encryption techniques: an encryption technique in supplying circuit information; and an encryption technique in storing the circuit information in the storage means.

A first circuit operation simulating system of the invention for simulating operation of a circuit based on supplied circuit information on a configuration and characteristics of the circuit is characterized by including: encryption means for encrypting circuit information to be supplied; transmission means for transmitting the encrypted circuit information via a network; reception means for receiving the transmitted circuit information; storage means for storing the received circuit information; stored circuit information decrypting means for reading out the encrypted circuit information from the storage means and decrypting the circuit information; simulation means for receiving the decrypted circuit information from the stored circuit information decrypting means and simulating operation of the circuit based on the received circuit information; intermediate data encrypting means for encrypting intermediate data generated during a simulation by the simulation means and storing the encrypted intermediate data in the storage means; and intermediate data decrypting means for reading out the encrypted intermediate data from the storage means, decrypting the intermediate data, and providing the decrypted intermediate data to the simulating means.

A second circuit operation simulating system of the invention for simulating operation of a circuit based on supplied circuit information on a configuration and characteristics of the circuit is characterized by including: first encryption means for encrypting circuit information to be supplied, by a first encryption technique; transmission means for transmitting the encrypted circuit information via a network; reception means for receiving the transmitted circuit information; first decrypting means for decrypting the received circuit information; second encryption means for encrypting, by a second encryption technique, the circuit information decrypted by the first decrypting means; storage means for storing the circuit information encrypted by the second encryption technique; second decrypting means for reading out the circuit information encrypted by the second encryption technique from the storage means and for decrypting the circuit information; and simulation means for receiving the decrypted circuit information from the second decrypting means and simulating operation of the circuit based on the received circuit information.

With these systems, circuit information for a simulation of circuit operation can also be supplied in an encrypted state so that confidentiality is ensured. Accordingly, the circuit information can be supplied in a flexible manner such as using the Internet or via a middleperson.

A third circuit operation simulating system of the invention for simulating operation of a circuit based on supplied circuit information on a configuration and characteristics of the circuit is characterized by including: first encryption means for encrypting circuit information to be supplied, by a first encryption technique; second encryption means for further encrypting, by a second encrypted technique, the circuit information encrypted by the first encryption technique; transmission means for transmitting the circuit information encrypted by the second encryption technique, via a network; reception means for receiving the transmitted circuit information; first decrypting means for decrypting the received circuit information encrypted by the second encryption technique and for outputting the circuit information encrypted by the first encryption technique; storage means for storing the circuit information output from the first decrypting means and encrypted by the first encryption technique; second decrypting means for reading out the circuit information encrypted by the first encryption technique from the storage means and for decrypting the circuit information; and simulation means for receiving the decrypted circuit information from the second decrypting means and simulating operation of the circuit based on the received circuit information.

With this system, the second encryption is performed by a provider of the circuit information. Accordingly, the configuration of the simulating apparatus used by a user and the processing of the apparatus can be simplified.

### BRIEF DESCRIPTION OF THE DRAWINGS

FIG. 1 is a block diagram showing a configuration of a main portion of a circuit operation simulating apparatus according to an embodiment of the present invention.

FIG. 2 is an explanatory diagram showing an example of encryption and decryption methods by a stored circuit information encrypting section 102 and other sections according to the embodiment.

FIG. 3 is an explanatory diagram showing an example of a circuit operation simulating system according to the embodiment.

FIG. 4 is an explanatory diagram showing another example of a circuit operation simulating system according to the embodiment.

### DESCRIPTION OF THE PREFERRED EMBODIMENTS

Hereinafter, an embodiment of the present invention will be described with reference to the drawings.

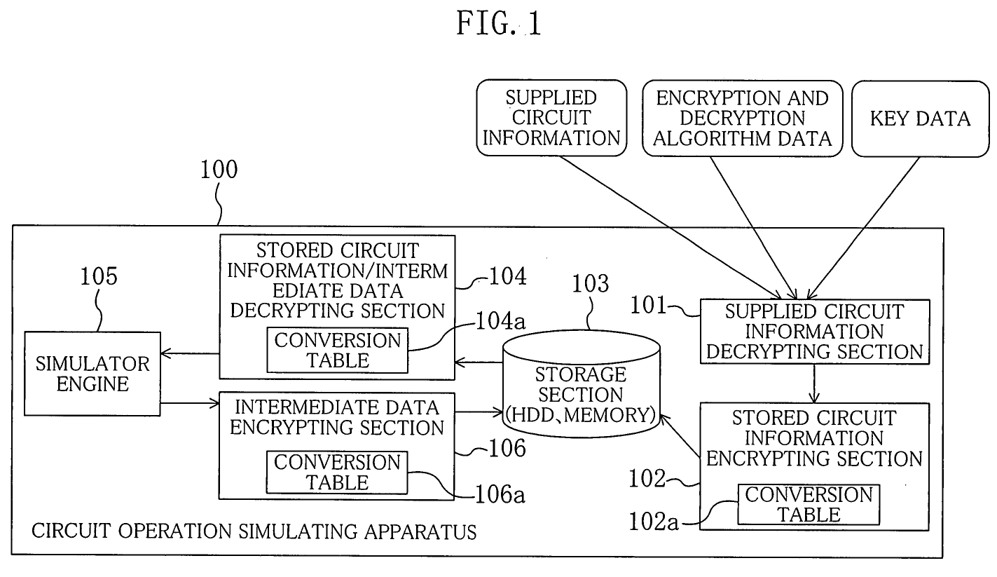

FIG. 1 is a block diagram showing a configuration of a main portion of a circuit operation simulating apparatus 100. In FIG. 1, a supplied circuit information decrypting section 101 (supplied circuit information decrypting means) decrypts supplied circuit information, which is encrypted circuit information, and generates plaintext circuit information, based on the supplied circuit information, encryption and decryption algorithm data (e.g., functions, programs or routines for use in encryption or decryption) and key data (e.g., initial values or passwords in decryption operation).

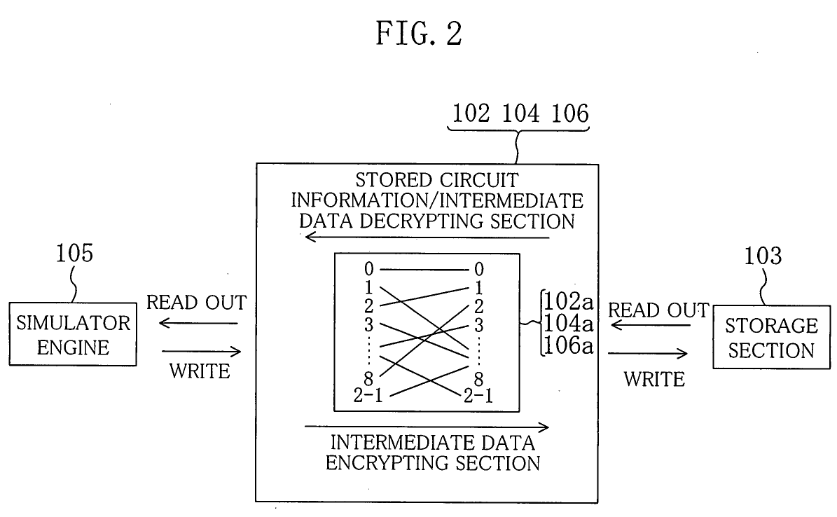

A stored circuit information encrypting section 102 (stored circuit information encrypting means) further encrypts the circuit information decrypted by the supplied circuit information decrypting section 101 to generate stored circuit information. This encryption is performed by data conversion based on a conversion table 102a, for example. More specifically, the encryption is performed by subjecting the plaintext circuit information to conversions into byte data in one-to-one correspondence with byte data as shown in FIG. 2, for example, complementary operations, exclusive OR operations for every two adjacent byte data items, and rearrangement of bits. That is to say, although encryption strength is lower than that for the supplied circuit information, encryption is performed with a method allowing encryption and decryption to be easily performed at high speed.

A storage section 103 (storage means) stores the encrypted stored circuit information, plaintext circuit information made by, for example, a user of the circuit operation simulating apparatus, intermediate data (temporary files or temporary data) during a simulation process and the like. The storage section 103 is configured with a hard disk drive (HDD) and a memory, for example. A method for distinguishing between the encrypted stored circuit information and the plaintext circuit information is not specifically limited. For example, the encrypted stored circuit information and the plaintext circuit information are easily distinguished by whether or not a symbol “*” is added to the head of each line or by the value of a given bit. The storage section 103 may be configured to temporarily hold supplied circuit information to be provided to the supplied circuit information decrypting section 101, encryption and decryption algorithm data and key data.

A stored circuit information/intermediate data decrypting section 104 (stored circuit information decrypting means and intermediate data decrypting means) decrypts the encrypted stored circuit information and the intermediate data stored in the storage section 103. This decryption is performed based on a conversion table 104a which is the same as or associated with, for example, the conversion table 102a of the stored circuit information encrypting section 102.

A simulator engine 105 (simulation means) simulates circuit operation based on the decrypted circuit information output from the stored circuit information/intermediate data decrypting section 104.

An intermediate data encrypting section 106 (intermediate data encrypting means) encrypts intermediate data output from the simulator engine 105 during the simulation, based on a conversion table 106a which is the same as the conversion table 102a, and stores the encrypted intermediate data in the storage section 103.

Specifically, such a circuit operation simulating apparatus as described above is configured with a computer including, for example, the storage section 103 and software programs respectively corresponding to the other sections. However, the inventive apparatus is not limited to this and may be partly constituted by hardware. Alternatively, in a case where the stored circuit information/intermediate data decrypting section 104, for example, is configured using software, programs such as plug-ins or add-on programs for expanding the function of the simulator engine 105, for example, may be used. In such a case, if only a mechanism allowing a plug-in to be incorporated into, for example, the simulator engine 105 is provided, the function of the circuit operation simulating apparatus can be easily expanded, thus providing the apparatus with functions of encrypting and decrypting the circuit information as described above, as well as providing the simulator engine 105 and the plug-in with universality. Alternatively, software for hooking, for example, an input or output routine of an existing simulator engine may be used to provide the above functions, for example. The circuit operation simulating apparatus is generally provided with an input device and a display device as well as the above devices, but these devices will be omitted in the following description.

When the circuit operation simulating apparatus thus configured performs a simulation, firstly, the supplied circuit information decrypting section 101 generates plaintext circuit information based on supplied circuit information, encryption and decryption algorithm data and key data. The stored circuit information encrypting section 102 encrypts the plaintext circuit information based on the conversion table 102a and stores the encrypted circuit information in the storage section 103. In this case, decryption by the supplied circuit information decrypting section 101 and encryption by the stored circuit information encrypting section 102 are performed continuously. Specifically, the circuit information decrypted within a processor of a computer, for example, is immediately converted into stored circuit information so that the entire plaintext circuit information is not held in the storage section 103 in an explicit form such as files. In this manner, the plaintext circuit information is not revealed by a general technique such as a technique of reading files stored in the storage section 103 or a memory dump.

The stored circuit information stored in the storage section 103 as described above and intermediate data which will be described later are decrypted by the stored circuit information/intermediate data decrypting section 104, when being referred to by the simulator engine 105. The circuit information stored in the form of plaintext such as the information made by the user is output to the simulator engine 105 without change.

The simulator engine 105 performs a simulation based on the plaintext data input from the stored circuit information/intermediate data decrypting section 104. Specifically, even if data stored in the storage section 103 is encrypted, decrypted plaintext data is input to the simulator engine 105 so that it is sufficient that the simulator engine 105 itself operates as in the known apparatus. A result obtained through the simulation is presented to the user of the circuit operation simulating apparatus by being displayed on a display, for example. Intermediate data generated during the simulation is not directly stored in the storage section 103 but is output to the intermediate data encrypting section 106, encrypted by the same technique as in the stored circuit information encrypting section 102, and then stored in the storage section 103. When this intermediate data is referred to by the simulator engine 105, the stored circuit information/intermediate data decrypting section 104 decrypts the data as described above.

When the simulation terminates, the intermediate data stored in the storage section 103 is completely deleted by the simulator engine 105 or a deleting section (intermediate data deleting means) not shown. This deletion not only releases a memory region or deletes file management information but also preferably overwrites the entity of the stored data with data such as dummy data or zero data to delete the entity. In the case of such a deletion, the intermediate data is not necessarily encrypted. In such a case, a certain degree of confidentiality is obtained. However, in a case where the intermediate data is encrypted, confidentiality is ensured with ease even if there occurs an unforeseen accident such as the occurrence of an error during the simulation or even if a temporary file or data in a memory is referred to before the termination of the simulation.

As described above, the supplied circuit information supplied to the circuit operation simulating apparatus is encrypted, so that it is possible to prevent the circuit information from being revealed to third parties (especially, with malicious intent) from when the circuit information is delivered from a manufacturer of the semiconductor integrated circuit, for example, to when the circuit information is received by a user of the circuit operation simulating apparatus (first confidentiality). In addition, both of the stored circuit information and the intermediate data stored in the storage section 103 have been encrypted, so that it is possible to prevent the circuit information from being revealed to the user of the apparatus (second confidentiality).

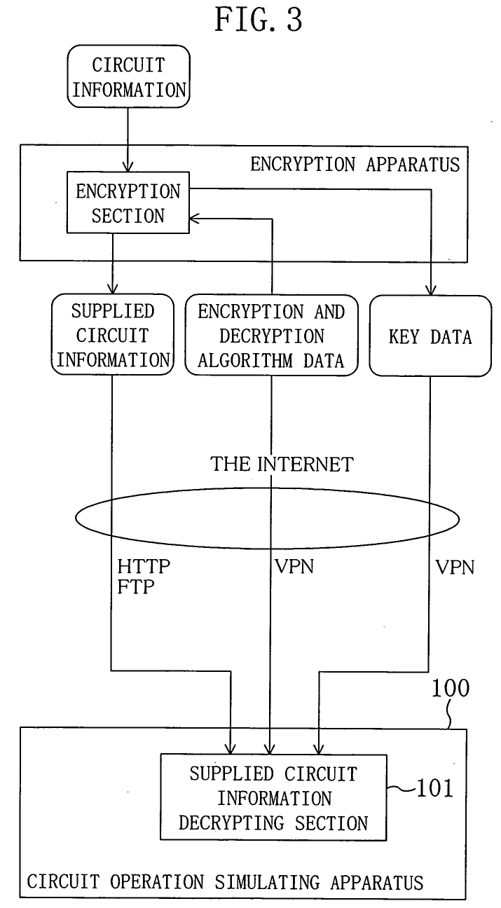

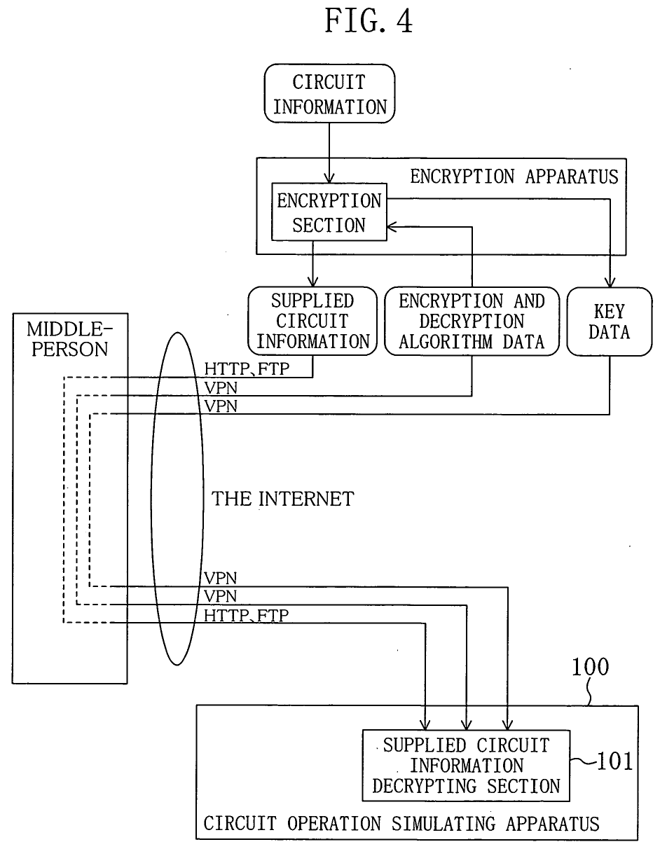

That is to say, with respect to the first confidentiality, decryption of the supplied circuit information by the supplied circuit information decrypting section 101 is performed based on the supplied circuit information, the encryption and decryption algorithm data and the key data. Therefore, if at least one of these data items is transmitted in a manner that does not allow the third parties to access the data item, the revelation of the circuit information is prevented easily. Specifically, for example, if the data is transmitted using connections with private lines, through the regular mail, or the like, the confidentiality can be easily ensured. It is also possible to verify that the receiver is an authorized user with a password or the like, using a virtual private network (VPN) utilizing the Internet, a security architecture for internet protocol (IPsec) or a point to point protocol (PPP) with, for example, a dial-up connection using a public network. In particular, the supplied circuit information can be transmitted by a hypertext transfer protocol (HTTP) or a file transfer protocol (FTP) via the Internet in a system as shown in FIG. 3 so long as the encryption and decryption algorithm data and/or the key data which do/does not need to be transmitted frequently. Therefore, circuits using various semiconductor integrated circuits and the like can be simulated easily without loss of confidentiality. In addition, in a system shown in FIG. 4, for example, the supplied circuit information, the encryption and decryption algorithm data and the key data, or at least part of these data items can be easily supplied via a middleperson dealing with the circuit information or the semiconductor integrated circuit or a server system at the middleperson side. That is to say, the convenience in distribution and management can be improved without loss of confidentiality. Moreover, even if a manufacturer of the circuit operation simulating system, the supplied circuit information decrypting section 101, the encryption and decryption algorithm data, or the like is different from the provider of the circuit information, it is possible to prevent the loss of the confidentiality of the circuit information.

The method for encryption is not specifically limited, and various private key cryptographies, public key cryptographies, or a method of performing encryption and decryption not using key data but using only encryption and decryption algorithm data may be used. In addition, the supplied circuit information, for example, may be transmitted using a secure socket layer (SSL) via the Internet. In such a case, a process section such as a special transport layer is preferably provided such that a result of processing by layers at levels higher than or equal to the transport layer is given only to the stored circuit information encrypting section 102.

On the other hand, with respect to the second confidentiality, the stored circuit information and the intermediate data to be stored in the storage section 103 are encrypted. Accordingly, even if a memory dump is performed or a file is opened by a program other than the simulator engine 105, the circuit information is not known to the user of the circuit operation simulating apparatus unless the content of the information is decrypted (analyzed). That is to say, the circuit information is not revealed to the user unless the user tries to acquire the circuit information fraudulently on purpose, so that it is unnecessary to conclude a contract for holding confidentiality such as an NDA. Therefore, the user can perform a sufficient simulation easily without restriction such as an obligation to hold confidentiality and, in addition, the revelation of the circuit information is prevented. In order to ensure that the circuit information or the like is not revealed or distributed to the others, it is preferable to conclude a contract or the like not to do such an act. However, such a contract does not restrict the user specifically and does not need strict procedures in general, so that it is easy to conclude the contract and it is also easy for a middleperson to conclude the contract as a deputy. Therefore, the simulation can be performed easily.

In the above example, the encryption and decryption algorithm data is supplied from the outside of the circuit operation simulating apparatus. However, the present invention is not limited to this example and the data may be previously included the circuit operation simulating apparatus or the supplied circuit information decrypting section 101, for example. It should be noted that if the data is to be supplied from the outside as described above, a latest supply encryption technique is easily applied as necessary. In addition, algorithms are set different depending on the supplied circuit information or its group or the user of the supplied circuit information, for example, so that the flexibility of the confidentiality management can be enhanced. The key data may also be set different depending on respective supplied circuit information items. Alternatively, the key data may be set different depending on the group of the supplied circuit information or the user.

In the above example, the conversion tables 102a, 104a and 106a are provided in the stored circuit information encrypting section 102, the stored circuit information/intermediate data decrypting section 104 and the intermediate data encrypting section 106, respectively. However, these sections may share a conversion table. Encryption and decryption methods using such conversion tables are generally advantageous in terms of processing speed. However, the present invention is not limited to this, and various encryption methods as described for the encryption of the supplied circuit information may be used. In particular, in a case where an encryption method associated with the supplied circuit information is used, the supplied circuit information provided may be decrypted directly by the stored circuit information/intermediate data decrypting section 104 without providing any of the supplied circuit information decrypting section 101 and the stored circuit information encrypting section 102. In a case where an encryption table (encryption tables), for example, is used, the table is not necessarily fixed but may be supplied from the outside. In such a case, the conversion table(s), for example, may be encrypted together with the circuit information and may be included in the circuit information to be supplied, for example.

All of the supplied circuit information and the stored circuit information encrypted by the stored circuit information encrypting section 102 and the intermediate data encrypting section 106 are not necessarily encrypted but may be encrypted in part with respect to the content which needs confidentiality. Specifically, if one of the characteristics of elements constituting the circuit and the connection relationship between the elements has know-how, for example, data related to the characteristics of the elements or the connection relationship may be encrypted.

In addition, the stored circuit information encrypting section 102 and the intermediate data encrypting section 106 are not necessarily provided separately and may be combined for the purpose of simplifying the configuration. Moreover, in a case where the encryption process and the decryption process are substantially the same (in such a case where if the same operation is performed twice, the data returns to the original data), the stored circuit information/intermediate data decrypting section 104 may also be combined therewith.

Furthermore, the provider of the circuit information may provide, as the supplied circuit information, circuit information which has been subjected to an encryption as the encryption performed on the stored circuit information generated by the stored circuit information encrypting section 102 and then subjected to an encryption associated with the encryption by the supplied circuit information decrypting section 101. In such a case, the stored circuit information decrypted by the supplied circuit information decrypting section 101 can be stored in the storage section 103 without change (without providing the stored circuit information encrypting section 102) so that a normal decryption program can be used as the supplied circuit information decrypting section 101 or self-extracting supplied circuit information can be used.

As described above, according to the present invention, by performing a simulation such that circuit information and intermediate data during the course of the simulation are encrypted and stored in the storage section and these data items are decrypted when being read out, the revelation of the circuit information to third parties and accidental revelation of the circuit information to the user of the circuit operation simulating apparatus can be prevented so that the simulation can be performed easily with confidentiality of the circuit information ensured. As a result, the flexibility in distribution and management of circuit information and semiconductor integrated circuits, for example, can be enhanced and the semiconductor integrated circuits can be distributed easily, for example.

What is claimed is:

1. A circuit operation simulating apparatus comprising:
simulation means for simulating operation of a circuit based on circuit information on a configuration and characteristics of the circuit;
storage means for storing encrypted circuit information;
stored circuit information decrypting means for reading out the encrypted circuit information from the storage means, decrypting the circuit information, and providing the decrypted circuit information to the simulation means;
intermediate data encrypting means for encrypting intermediate data generated during a simulation by the simulation means and storing the encrypted intermediate data in the storage means; and
intermediate data decrypting means for reading out the encrypted intermediate data from the storage means, decrypting the intermediate data, and providing the decrypted intermediate data to the simulation means.

2. The circuit operation simulating apparatus of claim 1, wherein the stored circuit information decrypting means and the intermediate data decrypting means are combined together.

3. The circuit operation simulating apparatus of claim 1, including intermediate data deleting means for deleting the intermediate data stored in the storage means, after the simulation has been terminated.

4. A circuit operation simulating apparatus comprising:
simulation means for simulating operation of a circuit based on circuit information on a configuration and characteristics of the circuit;
supplied circuit information decrypting means for decrypting supplied circuit information encrypted by a first encryption technique;
stored circuit information encrypting means for encrypting, by a second encryption technique, the circuit information decrypted by the supplied circuit information decrypting means;
storage means for storing the circuit information encrypted by the second encryption technique; and
stored circuit information decrypting means for reading out the circuit information encrypted by the second encryption technique from the storage means, decrypting the circuit information, and providing the decrypted circuit information to the simulation means.

5. The circuit operation simulating apparatus of claim 4, wherein the encryption by the first encryption technique has an encryption strength higher than that by the second encryption technique.

6. The circuit operation simulating apparatus of claim 4, wherein the encryption by the second encryption technique requires shorter time for encryption and decryption than that by the first encryption technique.

7. The circuit operation simulating apparatus of claim 4, wherein the circuit information decrypted by the supplied circuit information decrypting means is not stored in the storage means but encrypted by the stored circuit information encrypting means.

8. The circuit operation simulating apparatus of claim 4, including:
intermediate data encrypting means for encrypting intermediate data generated during a simulation by the simulation means and for storing the encrypted intermediate data in the storage means; and
intermediate data decrypting means for reading out the encrypted intermediate data from the storage means, decrypting the intermediate data, and providing the decrypted intermediate data to the simulation means,
wherein the stored circuit information encrypting means and the intermediate data encrypting means are combined together.

9. A circuit operation simulating apparatus comprising:
simulation means for simulating operation of a circuit based on circuit information on a configuration and characteristics of the circuit; and
storage means for storing encrypted circuit information,
wherein the circuit operation simulating apparatus is configured to be able to incorporate:
stored circuit information decrypting means for decrypting the encrypted circuit information read out from the storage means and for providing the circuit information to the simulation means;
intermediate data encrypting means for encrypting intermediate data generated during a simulation by the simulation means and for storing the encrypted intermediate data in the storage means; and
intermediate data decrypting means for decrypting the encrypted intermediate data read out from the storage means and for providing the decrypted intermediate data to the simulation means.

10. A circuit operation simulating apparatus comprising:
simulation means for simulating operation of a circuit based on circuit information on a configuration and characteristics of the circuit; and
storage means for storing encrypted circuit information,
wherein the circuit operation simulating apparatus is configured to be able to incorporate:
supplied circuit information decrypting means for decrypting supplied circuit information encrypted by a first encryption technique;
stored circuit information encrypting means for encrypting, by a second encryption technique, the circuit information decrypted by the supplied circuit information decrypting means, and for storing the encrypted circuit information in the storage means; and
stored circuit information decrypting means for decrypting the circuit information read out from the storage means and encrypted by the second encryption technique, and for providing the decrypted circuit information to the simulation means.

11. A circuit operation simulating method comprising:
a simulation step of simulating operation of a circuit based on circuit information on a configuration and characteristics of the circuit;
a stored circuit information decrypting step of reading out encrypted circuit information from storage means and decrypting the circuit information for use in the simulation step;
an intermediate data encrypting step of encrypting intermediate data generated during a simulation in the simulation step and of storing the encrypted intermediate data in the storage means; and
an intermediate data decrypting step of reading out the encrypted intermediate data from the storage means and decrypting the intermediate data for use in the simulation step.

12. A circuit operation simulating method comprising:
a simulation step of simulating operation of a circuit based on circuit information on a configuration and characteristics of the circuit;
a supplied circuit information decrypting step of decrypting supplied circuit information encrypted by a first encryption technique;
a stored circuit information encrypting step of encrypting, by a second encryption technique, the circuit information decrypted in the supplied circuit information decrypting step and of storing the encrypted circuit information in storage means; and
a stored circuit information decrypting step of reading out the circuit information encrypted by the second encryption technique from the storage means and of decrypting the circuit information for use in the simulation step.

13. A circuit operation simulating program which makes a computer execute:
a simulation step of simulating operation of a circuit based on circuit information on a configuration and characteristics of the circuit;
a stored circuit information decrypting step of reading out encrypted circuit information from storage means and decrypting the circuit information for use in the simulation step;
an intermediate data encrypting step of encrypting intermediate data generated during a simulation in the simulation step and of storing the encrypted intermediate data in the storage means; and
an intermediate data decrypting step of reading out the encrypted intermediate data from the storage means and decrypting the intermediate data for use in the simulation step.

14. A circuit operation simulating program which makes a computer execute:
a simulation step of simulating operation of a circuit based on circuit information on a configuration and characteristics of the circuit; and
a supplied circuit information decrypting step of decrypting supplied circuit information encrypted by a first encryption technique,
a stored circuit information encrypting step of encrypting, by a second encryption technique, the circuit information decrypted in the supplied circuit information decrypting step and of storing the encrypted circuit information in storage means, and
a stored circuit information decrypting step of reading out the circuit information encrypted by the second encryption technique from the storage means and of decrypting the circuit information for use in the simulation step.

15. A circuit operation simulating system for simulating operation of a circuit based on supplied circuit information on a configuration and characteristics of the circuit,
the system comprising:
encryption means for encrypting circuit information to be supplied;
transmission means for transmitting the encrypted circuit information via a network;
reception means for receiving the transmitted circuit information;
storage means for storing the received circuit information;
stored circuit information decrypting means for reading out the encrypted circuit information from the storage means and decrypting the circuit information;
simulation means for receiving the decrypted circuit information from the stored circuit information decrypting means and simulating operation of the circuit based on the received circuit information;
intermediate data encrypting means for encrypting intermediate data generated during a simulation by the simulation means and storing the encrypted intermediate data in the storage means; and
intermediate data decrypting means for reading out the encrypted intermediate data from the storage means, decrypting the intermediate data, and providing the decrypted intermediate data to the simulating means.

16. A circuit operation simulating system for simulating operation of a circuit based on supplied circuit information on a configuration and characteristics of the circuit,
the system comprising:
first encryption means for encrypting circuit information to be supplied, by a first encryption technique;
transmission means for transmitting the encrypted circuit information via a network;
reception means for receiving the transmitted circuit information;
first decrypting means for decrypting the received circuit information;
second encryption means for encrypting, by a second encryption technique, the circuit information decrypted by the first decrypting means;
storage means for storing the circuit information encrypted by the second encryption technique;
second decrypting means for reading out the circuit information encrypted by the second encryption technique from the storage means and for decrypting the circuit information; and
simulation means for receiving the decrypted circuit information from the second decrypting means and simulating operation of the circuit based on the received circuit information.

17. A circuit operation simulating system for simulating operation of a circuit based on supplied circuit information on a configuration and characteristics of the circuit,
the system comprising:
first encryption means for encrypting circuit information to be supplied, by a first encryption technique;
second encryption means for further encrypting, by a second encrypted technique, the circuit information encrypted by the first encryption technique;
transmission means for transmitting the circuit information encrypted by the second encryption technique, via a network;
reception means for receiving the transmitted circuit information;
first decrypting means for decrypting the received circuit information encrypted by the second encryption technique and for outputting the circuit information encrypted by the first encryption technique;
storage means for storing the circuit information output from the first decrypting means and encrypted by the first encryption technique;
second decrypting means for reading out the circuit information encrypted by the first encryption technique from the storage means and for decrypting the circuit information; and
simulation means for receiving the decrypted circuit information from the second decrypting means and simulating operation of the circuit based on the received circuit information.
